(19) United States
(12) Patent Application Publication
(10) Pub. No.: US 2014/0092102 A1
(43) Pub. Date: Apr. 3, 2014

(54) CIRCUIT AND METHOD FOR DYNAMIC CLOTH SIMULATION AND GRAPHICS PROCESSING UNIT EMPLOYING THE SAME

(71) Applicant: NVIDIA CORPORATION, Santa Clara, CA (US)

(72) Inventor: Christian Sigg, Zurich (CH)

(73) Assignee: NVIDIA CORPORATION, Santa Clara, CA (US)

(21) Appl. No.: 13/630,484

(22) Filed: Sep. 28, 2012

(51) Int. Cl. G06F 17/11; G06F 15/00

(52) U.S. Cl. 345/501; 703/2

(57) ABSTRACT

A system and method for solving a non-linear system of equations regarding particles representing a cloth and a graphics processing subsystem incorporating the system or the method. In one embodiment, the system includes: (1) a linearization circuit configured to employ data representing a property of the particles to construct a linear system of constraints with respect to the property and (2) a solver circuit coupled to the linearization circuit and configured to compute for the particles correction components applicable to satisfy the linear system and thereby solve the non-linear system.

### TECHNICAL FIELD

This application is directed, in general, to computer graphics and, more specifically, to techniques for solving systems of equations encountered in the context of dynamic cloth simulations.

### BACKGROUND

Graphics processing frequently involves rendering a piece of cloth as it interacts with a surrounding environment. Characters in a game or animation wear clothing; banners and flags wave in a strong wind; or curtains drape loosely over open windows. All of these benefit from a simulation of how the cloth moves, tangles, folds, and stretches over time.

Increased application of real-time graphics processing has created a pervasive demand for ever increasing realism and high speed rendering. Early attempts at simulating cloth dynamics led applications to implement a limited set of interactions, or no interactions at all. For example, the clothing on a character would not correctly react to the character changing his walking direction, or would not collide with the character's body or the environment. Another example is a curtain unaffected by wind or by a stone thrown at it. This lack of realism has burdened the graphics processing industry ever since.

More recent approaches to dynamic cloth simulation model a piece of cloth as a collection of particles, each particle subject to effects of the environment. This model is a significant departure from the limited “canned” animations mentioned above. This model allows users of a simulation to interact with the cloth with a great amount of freedom and uniqueness. One user may choose to sprint down an aisle or jump over an obstacle, while another may choose to crawl and crouch. Each scenario drives the simulation down a unique path, ultimately treating the cloth as any other physical object in the environment.

While the latter approach lends itself to realistic simulation, real-time simulation becomes a challenge. An ideal simulation models the cloth as a collection of infinitely small particles, each moving and constrained with respect to the others. Simulation of all those particles quickly becomes impractical in the realm of real-time applications. Applying the effects of the environment on the particles and maintaining the relationships among the particles is computationally expensive. The problem worsens with less elastic cloth or as the number of particles increases. To satisfy the real-time demand, applications find clever ways to use fewer particles and more elastic properties, which amount to greater tolerance on the movement of cloth particles and modeling a cloth as more elastic than in reality. Many applications reduce solving time by terminating iterative processes after a certain amount of time or number of iterations. The resulting inaccuracies are usually small and the simulation yields fairly realistic cloth dynamics, with only minor noticeable “glitches.”

### SUMMARY

A system for solving a non-linear system of equations regarding particles representing a cloth. In one embodiment, the system includes: (1) a linearization circuit configured to employ data representing a property of the particles to construct a linear system of constraints with respect to the property and (2) a solver circuit coupled to the linearization circuit and configured to compute for the particles correction components applicable to satisfy the linear system and thereby solve the non-linear system.

Another aspect provides a method of simulating cloth dynamics. In one embodiment, the method includes: (1) representing a cloth as particles, (2) forming constraints regarding adjacent ones of the particles into a non-linear system, (3) linearizing the constraints to form a linear system, (4) approximating the linear system as tri-diagonal matrices and (5) solving the tri-diagonal matrices to yield correction components.

Yet another aspect provides a graphics processing subsystem. In one embodiment, the subsystem includes: (1) a memory configured to store particles representing a cloth and (2) a graphics processing unit configured to solve a non-linear system of equations regarding the particles. In one embodiment, the GPU has: (2a) a linearization circuit configured to employ data representing a property of the particles to construct a linear system of constraints with respect to the property, the property selected from the group consisting of distances separating the particles and relative velocities among the particles and (2b) a solver circuit coupled to the linearization circuit and configured to compute for the particles correction components applicable to satisfy the linear system and thereby solve the non-linear system.

### BRIEF DESCRIPTION

Reference is now made to the following descriptions taken in conjunction with the accompanying drawings, in which:

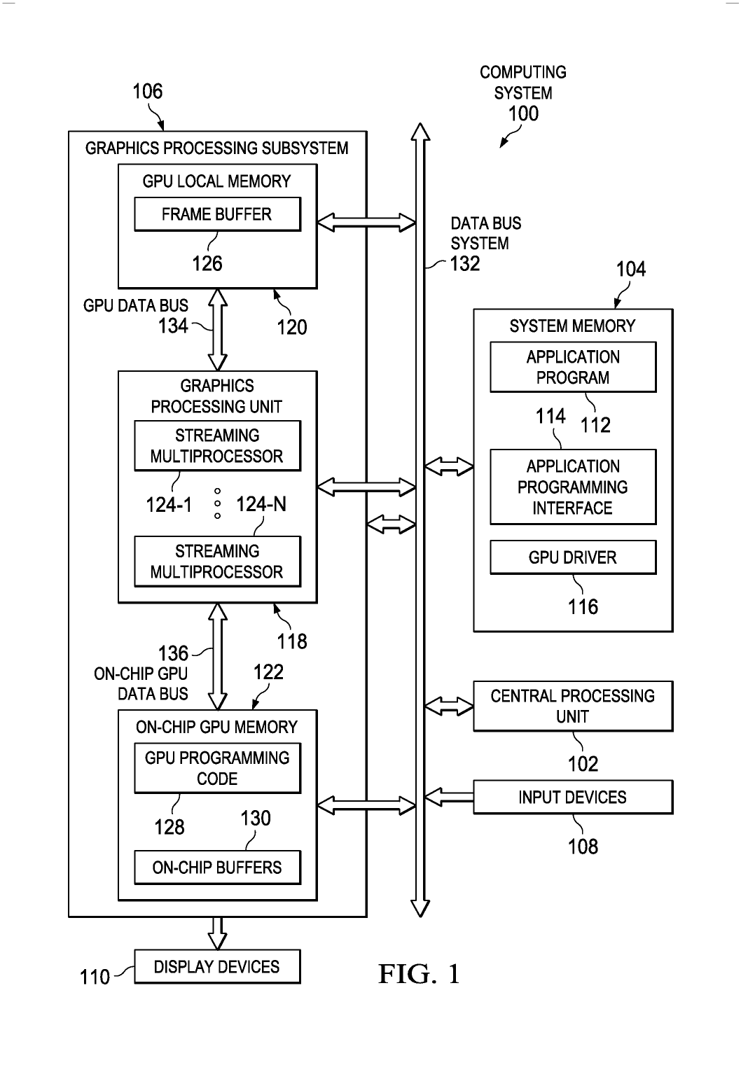

FIG. 1 is a block diagram of one embodiment of a computing system in which one or more aspects of the invention may be implemented;

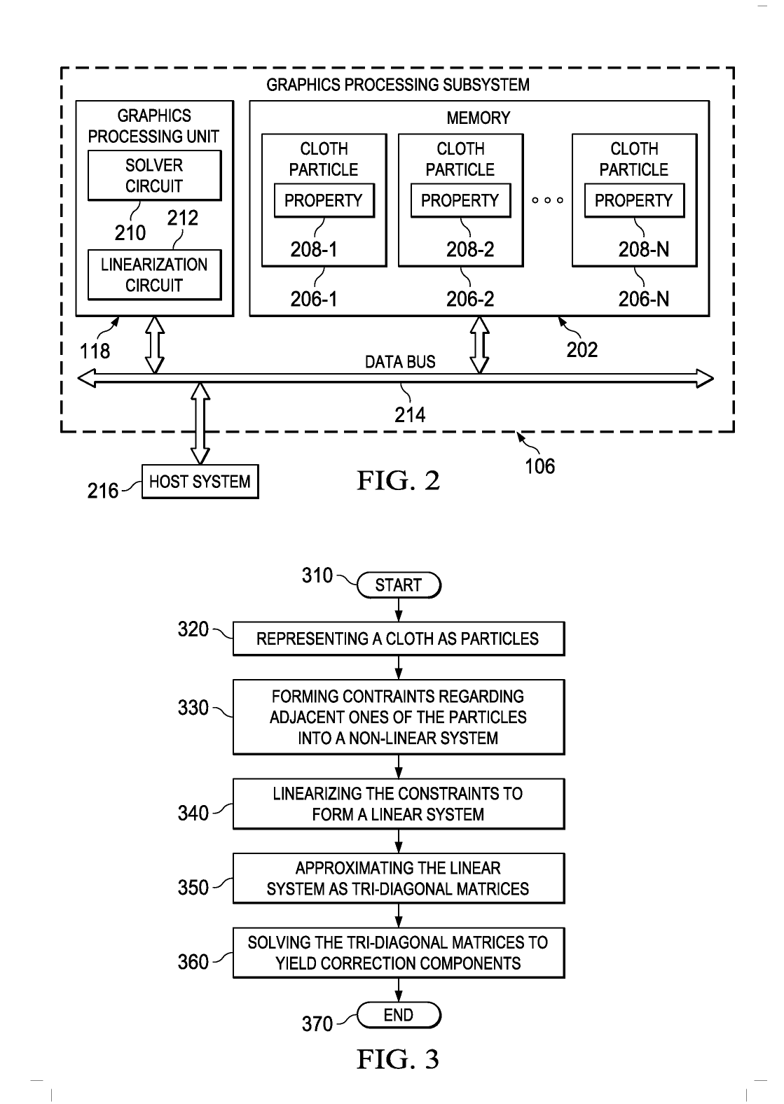

FIG. 2 is a block diagram of one embodiment of a system for simulating cloth dynamics; and

FIG. 3 is a flow diagram of one embodiment of a method of simulating cloth dynamics.

### DETAILED DESCRIPTION

Before describing various embodiments of the circuit or method introduced herein, cloth simulation will be generally described.

Several approaches exist for simulating a cloth in computer graphics. One popular approach is a forced-based approach, where internal and external forces are accumulated and accelerations, velocities, and positions are derived. As applied to a collection of cloth particles, a simulation computes these dynamics for each particle. The simulation calls for a different acceleration to be computed for each particle that, over time, yields velocities and positions that tug on the relationships among the particles. These relationships are known as “constraints.”

In the force-based approach, the cloth is modeled as a collection of particles coupled by springs, of which the stiffness of the springs is proportional to the inelasticity of the cloth. The constraints among the particles are therefore spring forces. A force applied on one particle acts to compress or stretch a spring coupling the one particle to another. The other particle is accelerated as a result. As the forces on each particle are integrated and the resulting spring forces applied to nearby particles, the particles converge on a new state where all constraints are satisfied.

Another approach models the cloth as a collection of particles coupled by distance and velocity constraints. This is known as the impulse approach. When the cloth is at rest, two particles are separated by a distance. Based on the elasticity of the cloth, a tolerance on the distance is applied such that the two particles may not be separated beyond their shared elastic constraint. Similarly, a system may employ a velocity constraint such that the velocity of two particles may not differ by more than some velocity tolerance. The constraints are enforced by applying equal opposing impulses to the two particles subject to the constraint. The impulses, in distance or velocity, resolve the constraint by directly adjusting the dynamics of the particles.

In either approach, the simulation models the cloth over some time period that is divided into discrete time steps. A one-hertz simulation has a time step of one second and therefore one update cycle per second. A 20-hertz simulation has twenty update cycles per second; a 60-hertz simulation has 60 update cycles per second; and so on. Each update cycle of the cloth simulation has a first phase which moves the particles according to their velocities and applies external forces like gravity. The particles move independently, potentially violating their constraints. A second phase seeks to resolve the constraints.

A relationship (or constraint) exists among one particle and each other particle in the cloth. The aggregated relationships among all particles form a non-linear system of constraints. To resolve one constraint element, is to disrupt the resolve of another. The process iterates and converges on a solution that satisfies the system. Alternatively, it is realized herein that the system of constraints may be represented as a linear system of equations and all constraints solved concurrently.

It is realized herein that the particles may be organized into linear “fibers” such that one particle is constrained only by two of its neighboring particles. A resulting fiber of constraints forms with each consecutive constraint being nearby and maximally parallel to the last. It is realized herein that organizing the entire collection of particles into parallel independent fibers can yield a system having a perfect elimination order. It is realized herein the ordering of the constraints into fibers is analogous to swapping rows and columns when solving a linear system, a process called “pivoting,” which is used in Gaussian elimination and yields better convergence. The elimination can be carried out without creating additional non-zero elements.

It is further realized herein that the resulting linear system is a tri-diagonal system, which is solvable in linear time. Traditional methods such as Gauss-Seidel are iterative, as opposed to the direct solving method realized herein. The direct method yields better convergence and therefore better performance than iterative methods.

It is further realized herein that convergence is further improved by continually linearizing the system throughout the Gaussian elimination steps. The first phase of the elimination is forward elimination that iterates over the constraints in one direction to reduce the system to a triangular form. The second phase is backward substitution that iterates over the constraints in the opposite direction to find the solution of the system. It is realized herein the traditional technique of linearizing constraints, solving for Lagrange multipliers (forward elimination), and then applying the Lagrange multipliers (backward substitution) is burdensomely inefficient and slows convergence. It is realized herein that as a constraint is solved, the result can be immediately linearized, thus applying the best known dynamics to the particles. It is realized herein the partial or full solution of each previous constraint reduces error in each subsequent constraint and improves overall convergence.

It is also realized herein the organizing of constraints into fibers lends itself to parallel processing. Non-overlapping fibers represent independent groups of linear constraints that can be solved concurrently. It is realized herein a combination of using Gaussian elimination in solving the tri-diagonal matrices and distributing the solving of independent fibers over multiple processing cores provides for an optimal balance of parallel and sequential processing.

Before describing various embodiments of the novel circuit and method for simulating cloth dynamics, a computing system within which the circuit may be embodied or the method carried out will be described.

FIG. 1 is a block diagram of one embodiment of a computing system 100 in which one or more aspects of the invention may be implemented. The computing system 100 includes a system data bus 132, a central CPU 102, input devices 108, a system memory 104, a graphics processing subsystem 106, and display devices 110. In alternate embodiments, the CPU 102, portions of the graphics processing subsystem 106, the system data bus 132, or any combination thereof, may be integrated into a single processing unit. Further, the functionality of the graphics processing subsystem 106 may be included in a chipset or in some other type of special purpose processing unit or co-processor.

As shown, the system data bus 132 connects the CPU 102, the input devices 108, the system memory 104, and the graphics processing subsystem 106. In alternate embodiments, the system memory 100 may connect directly to the CPU 102. The CPU 102 receives user input from the input devices 108, executes programming instructions stored in the system memory 104, operates on data stored in the system memory 104, and configures the graphics processing subsystem 106 to perform specific tasks in the graphics pipeline. The system memory 104 typically includes dynamic random access memory (DRAM) used to store programming instructions and data for processing by the CPU 102 and the graphics processing subsystem 106. The graphics processing subsystem 106 receives instructions transmitted by the CPU 102 and processes the instructions in order to render and display graphics images on the display devices 110.

As also shown, the system memory 104 includes an application program 112, an application programming interface (API) 114, and a graphics processing unit (GPU) driver 116. The application program 112 generates calls to the API 114 in order to produce a desired set of results, typically in the form of a sequence of graphics images.

The graphics processing subsystem 106 includes a GPU 118, an on-chip GPU memory 122, an on-chip GPU data bus 136, a GPU local memory 120, and a GPU data bus 134. The GPU 118 is configured to communicate with the on-chip GPU memory 122 via the on-chip GPU data bus 136 and with the GPU local memory 120 via the GPU data bus 134. The GPU 118 may receive instructions transmitted by the CPU 102, process the instructions in order to render graphics data and images, and store these images in the GPU local memory 120. Subsequently, the GPU 118 may display certain graphics images stored in the GPU local memory 120 on the display devices 110.

The GPU 118 includes one or more streaming multiprocessors 124. Each of the streaming multiprocessors 124 is capable of executing a relatively large number of threads concurrently. Advantageously, each of the streaming multiprocessors 124 can be programmed to execute processing tasks relating to a wide variety of applications, including but not limited to linear and nonlinear data transforms, filtering of video and/or audio data, modeling operations (e.g., applying of physics to determine position, velocity, and other attributes of objects), and so on. The GPU 118 may be provided with any amount of on-chip GPU memory 122 and GPU local memory 120, including none, and may use on-chip GPU memory 122, GPU local memory 120, and system memory 104 in any combination for memory operations.

The on-chip GPU memory 122 is configured to include GPU programming code 128 and on-chip buffers 130. The GPU programming 128 may be transmitted from the GPU driver 116 to the on-chip GPU memory 122 via the system data bus 132.

The GPU local memory 120 typically includes less expensive off-chip dynamic random access memory (DRAM) and is also used to store data and programming used by the GPU 118. As shown, the GPU local memory 120 includes a frame buffer 126. The frame buffer 126 stores data for at least one two-dimensional surface that may be used to drive the display devices 110. Furthermore, the frame buffer 126 may include more than one two-dimensional surface so that the GPU 118 can render to one two-dimensional surface while a second two-dimensional surface is used to drive the display devices 110.

The display devices 110 are one or more output devices capable of emitting a visual image corresponding to an input data signal. For example, a display device may be built using a cathode ray tube (CRT) monitor, a liquid crystal display, or any other suitable display system. The input data signals to the display devices 110 are typically generated by scanning out the contents of one or more frames of image data that is stored in the frame buffer 126.

Having described a computing system within which the circuit and method for simulating cloth dynamics may be embodied or carried out, various embodiments of the circuit and method will be described.

FIG. 2 is a block diagram of one embodiment of a graphics processing subsystem 106. Within the subsystem 106 of FIG. 1 is a GPU 118, also of FIG. 1, configured to interface with a memory 202 and host system 216 via a data bus 214. Alternative embodiments may integrate the GPU 118 and memory 202 such that communication over the data bus 214 is unnecessary but for communicating with the host system 216. Still other embodiments provide for a dedicated data bus for host communication or for memory communication. In the embodiment of FIG. 2 the memory 202 is configured to store N cloth particles 206, each cloth particle 206-1 through 206-N having a property 208.

The GPU 118 contains a solver circuit 210 and a linearization circuit 212. The linearization circuit 212 is configured to employ the properties 208-1 through 208-N to construct a linear system of constraints with respect to the properties 208-1 through 208-N. The solver circuit 210 is coupled to the linearization circuit 212 and configured to compute correction impulses applicable to the cloth particles 206-1 through 206-N thereby solving the linear system of constraints. In certain embodiments the solving circuit 212 is configured to employ a Gaussian elimination technique to directly solve the linear system of constraints. Other solving circuit 212 embodiments may employ alternative direct solving techniques. Certain embodiments employ the linearization circuit 212 before employing the solver circuit 210. Alternative embodiments employ the two circuits 210 and 212 concurrently.

In certain embodiments the properties 208-1 through 208-N are distances between a first cloth particle 206-n and a second cloth particle 206-n+1. In other embodiments, the properties 208-1 through 208-N are velocities of the cloth particles 206-1 through 206-N.

FIG. 3 is a flow diagram of one embodiment of a method of simulating a piece of cloth and its dynamics. The method begins in a begin step 310. The cloth is decomposed into a collection of cloth particles in a step 320. The particles, representing the cloth, form a basis for a non-linear system of constraints in a step 330. In certain embodiments, the constraints formulated are relative distances or relative velocities between two particles. In other embodiments, the constraints may be spring forces modeling the elasticity of the cloth. In the method of FIG. 3, the non-linear system of constraints is linearized in a step 340. In a step 350, the linear system is approximated by independent parallel fibers of constraints, represented by tri-diagonal matrices. The tri-diagonal matrices are solved in a solving step 360, yielding correction components or impulses. In certain embodiments, the impulses are arrived at by way of a Gaussian elimination technique. In other embodiments, the method includes a regularizing step initiated when one of the tri-diagonal matrices is recognized to be singular, meaning it cannot be solved directly. However, it can be regularized and solved. Accordingly, regularizing the singular tri-diagonal matrix allows a continuation to the solving step 360. Returning to the method of FIG. 3, when applied to the cloth particles, the impulses from the solving step 360 stand as a solution to the non-linear system of constraints. The method of FIG. 3 then ends at step 370. In alternative embodiments, the linearization is carried out throughout the solving step 360, thereby improving the convergence on the solution to the non-linear system. Having been simulated, the cloth may then be rendered with texture and color and caused to be displayed on a computer display, for example.

Those skilled in the art to which this application relates will appreciate that other and further additions, deletions, substitutions and modifications may be made to the described embodiments.

What is claimed is:

1. A system for solving a non-linear system of equations regarding particles representing a cloth, comprising:
a linearization circuit configured to employ data representing a property of said particles to construct a linear system of constraints with respect to said property; and
a solver circuit coupled to said linearization circuit and configured to compute for said particles correction components applicable to satisfy said linear system and thereby solve said non-linear system.

2. The system as recited in claim 1 wherein said linear system is ordered such that a series of adjacent, substantially parallel constraints form a dependent fiber.

3. The system as recited in claim 2 wherein said series is independent of constraints outside of said fiber.

4. The system as recited in claim 1 wherein said property is distances separating said particles.

5. The system as recited in claim 1 wherein said property is relative velocities among said particles.

6. The system as recited in claim 1 wherein said linearization circuit and said solver circuit are configured to operate concurrently.

7. The system as recited in claim 1 wherein said solver circuit is configured to employ a forward elimination and a backward substitution to compute said correction component for each of said particles.

8. A method of simulating cloth dynamics, comprising:
representing a cloth as particles;
forming constraints regarding adjacent ones of said particles into a non-linear system;
linearizing said constraints to form a linear system;
approximating said linear system as tri-diagonal matrices; and
solving said tri-diagonal matrices to yield correction components.

9. The method as recited in claim 8 wherein said constraints are with respect to distances separating said particles.

10. The method as recited in claim 8 wherein said constraints are with respect to relative velocities among said particles.

11. The method as recited in claim 8 further comprising concurrently:
repeating said linearizing; and
iteratively carrying out said solving.

12. The method as recited in claim 8 wherein each of said tri-diagonal matrices represents a fiber of dependent constraints.

13. The method as recited in claim 8 wherein said solving comprises employing a forward elimination and a backward substitution.

14. The method as recited in claim 8 wherein a matrix of said tri-diagonal matrices is singular, said method further comprising regularizing of said singular matrix before carrying out said solving.

15. A graphics processing subsystem comprising:
a memory configured to store particles representing a cloth; and
a graphics processing unit configured to solve a non-linear system of equations regarding said particles, said graphics processing unit including:
a linearization circuit configured to employ data representing a property of said particles to construct a linear system of constraints with respect to said property, said property selected from the group consisting of distances separating said particles and relative velocities among said particles, and
a solver circuit coupled to said linearization circuit and configured to compute for said particles correction components applicable to satisfy said linear system and thereby solve said non-linear system.

16. The subsystem as recited in claim 15 wherein said linear system is ordered such that a series of adjacent, parallel constraints form a dependent fiber.

17. The subsystem as recited in claim 16 wherein said series is independent of constraints outside of said fiber.

18. The subsystem as recited in claim 15 wherein said linearization circuit and said solver circuit are configured to operate concurrently.

19. The subsystem as recited in claim 15 wherein said solver circuit is configured to employ a Gaussian elimination technique to compute said correction component for each of said particles.

20. The subsystem as recited in claim 15 wherein said solver circuit is configured to regularize and solve singular partitions of said linear system.
